(19) United States
(12) Patent Application Publication
(10) Pub. No.: US 2022/0165450 A1
(43) Pub. Date: May 26, 2022

(54) NANOWIRE INK PERFORMANCE CORRELATION TO NANOWIRE DIMENSION

(71) Applicant: Cambrios Films Solutions Corporation, Tortola (VG)

(72) Inventors: Jeff Alan WOLK, Half Moon Bay, CA (US); Michael Andrew SPAID, Mountain View, CA (US)

(21) Appl. No.: 17/600,742

(22) PCT Filed: Apr. 1, 2020
(86) PCT No.: PCT/US2020/026061

§ 371 Date: Oct. 1, 2021

Related U.S. Application Data
(60) Provisional application No. 62/828,674, filed on Apr. 3, 2019.

(51) Int. Cl. H01B 5/14; H01B 1/02; C09D 11/52

(52) U.S. Cl. CPC H01B 5/14; C09D 11/52; H01B 1/02

(57) ABSTRACT

A method for predicting at least one performance property of a transparent conductive film to be made from an ink containing nanowires prior to making the transparent conductive film. The method includes obtaining a nanowire population from the ink for analysis. The method includes determining at least one of lengths and diameters for all the nanowires within the population from the ink. The method includes comparing the determined at least one of lengths and diameters to a value index that is correlated to the at least one performance property of the to-be-made transparent conductive film.

### RELATED APPLICATION

This application claims priority to U.S. Provisional Application Ser. No. 62/828,674, titled “INK” and filed on Apr. 3, 2019, which is incorporated herein by reference.

### FIELD

This disclosure is related to evaluation of nanowire dimensions for the purpose of predicting optical performance of a transparent conductive film that could be made using an ink containing such nanowires.

### BACKGROUND

Transparent conductive films include optically-clear and electrically-conductive films such as those commonly used in touch-sensitive computer displays. Generally, conductive nanowires connect with each other to form a percolating network having long-range interconnectivity. The percolating network is connected to electronic circuits of a computer, tablet, smart phone, or other computing device.

During production of a transparent conductive film, an ink is utilized. The ink minimally contains the nanowires suspended in a solvent such as water or IPA, with additional optional constituents to improve the coating quality, such as binders, surfactants, co-solvents, and the like. It is typically desired to produce a nanowire-containing ink that will ultimately produce a transparent conductive film that has at least one desirable performance property, such as an optical performance property. However, a determination of whether a produced transparent conductive film has the desirable performance property occurs after the transparent conductive film is produced. If the produced transparent conductive film does not have the desirable performance property, such could result in wasted time, materials and cost concerning the production.

### BRIEF SUMMARY

According to an aspect, the subject disclosure provides a method for predicting at least one performance property of a transparent conductive film to be made from an ink containing nanowires. The method includes obtaining a nanowire population from the ink for analysis. The method includes determining at least one of lengths and diameters for all the nanowires within the population from the ink. The method includes comparing the determined at least one of lengths and diameters to a value index that is correlated to the at least one performance property of the to-be-made transparent conductive film.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWING

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

The disclosed subject matter may take physical form in certain parts and arrangement of parts, embodiments of which will be described in detail in this specification and illustrated in the accompanying drawings which form a part hereof and wherein:

FIG. 1 is a flowchart of an example method in accordance with an aspect of the present disclosure.

FIGS. 2A and 2B are plots of diameter vs length of example batches of nanowires.

FIGS. 3A and 3B are plots of diameter vs length of example batches of nanowires.

FIG. 4 is a plot of percent haze vs sheet resistance for example batches of nanowires.

FIG. 5 is an image of an example spin coater that can be used in conjunction with a method of the present disclosure.

FIG. 6 an enlarged image of typical nanowires provided via the spin coater of FIG. 5.

FIG. 7 is an image of a microscope that can be used in conjunction with a method of the present disclosure.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any illustrative embodiments set forth herein as examples. Rather, the embodiments are provided herein merely to be illustrative.

The following subject matter may be embodied in a variety of different forms, such as methods, devices, components, and/or systems. Accordingly, this subject matter is not intended to be construed as limited to any illustrative embodiments set forth herein as examples. Rather, the embodiments are provided herein merely to be illustrative.

Provided herein is a method for predicting at least one performance property of a transparent conductive film to be made from an ink containing nanowires. The method includes obtaining a nanowire population from the ink for analysis. The method includes determining at least one of lengths and diameters for all the nanowires within the population from the ink. The method includes comparing the determined at least one of lengths and diameters to a value index that is correlated to the at least one performance property of the to-be-made transparent conductive film.

The morphology of a given nanowire can be defined in a simplified fashion by its aspect ratio, which is the ratio of the length over the diameter of the nanowire. For instance, certain nanowires are isotropically shaped (i.e., aspect ratio=1). In example embodiments, the nanowires are anisotropically shaped (i.e., aspect ratio≠1). The anisotropic nanowire typically has a longitudinal axis along its length.

Nanowires (“NWs”) typically refers to long, thin nanostructures having aspect ratios of greater than 10, preferably greater than 50, and more preferably greater than 100. Typically, the NWs are more than 500 nm, more than 1 μm, or more than 10 μm long. Although the present disclosure is applicable to any type of nanowire, some discussions herein with be directed to silver nanowires (can be presented as “AgNWs” or abbreviated simply as “NWs”) will be described as an example.

Electrical and optical properties of a transparent conductor (TC) layer are strongly dependent on the physical dimensions of NWs—i.e. their length and diameter, and more generally, their aspect ratio. In general, networks comprised of nanowires with larger aspect ratios form conductive networks with superior optical properties; in particular lower haze. Because each NW can be considered a conductor, individual NW length and diameter will affect the overall NW network conductivity and, therefore, the final film conductivity. For example, as nanowires get longer, fewer are needed to make a conductive network; and as NWs get thinner, NW resistivity increases—making the resulting film less conductive for a given number of NWs.

Similarly, NW length and diameter will affect the optical transparency and light diffusion (haze) of the TC layers. NW networks are optically transparent because nanowires comprise a very small fraction of the film. However, the nanowires absorb and scatter light, so NW length and diameter will, in large part, determine optical transparency and haze for a conductive NW network. Generally, thinner NWs can provide reduced haze in TC layers—a desired property for electronic applications.

Focusing upon some possible nanowires that may not provide some desired qualities, some low aspect ratio nanowires (a byproduct of the synthesis process) in the TC layer result in added haze as these structures scatter light without contributing significantly to the conductivity of the network. Because synthetic methods for preparing metal nanowires typically produce a composition that includes a range of nanowire morphologies, both desirable and undesirable. There can be a need to purify such a composition to promote retention of high aspect ratio nanowires. The retained nanowires can be used to form TCs having desired electrical and optical properties. Alternatively, the nanowires can simply be of insufficient quality to produce desired results. Thus, one or more characteristics of nanowires have impact upon one or more performance properties of a transparent conductive film.

One or more performance properties of a transparent conductive film can be readily tested, measured, determined or the like once the transparent conductive film is made. However, such does require that the transparent conductive film be produced.

As mentioned, determining at least one of lengths and diameters for all the nanowires within the population from the ink is used to predict at least one performance property of transparent conductive film that could be made using the ink with the nanowires therein. It is to be appreciated that any of several methods, structure(s)/device(s), etc. could be utilized to make one or more determinations about at least one of lengths and diameters for all the nanowires. Within an example, a spin coater and a microscope, with the microscope in reflected light, dark field mode, are utilized.

It is to be appreciated that the at least one performance property of the to-be-made transparent conductive film can be any one or more of several performance properties. As an example, an optical property of the film is a performance property. Within a specific example, the optical property can be haze. Within a specific example, the optical property is diffuse reflection.

It is to be appreciated that the at least one of lengths and diameters of the nanowires, can have different effects upon different performance properties. It is to be appreciated that various performance properties could be affected by both lengths and diameters of the nanowires. It is to be appreciated that lengths and/or diameters of the nanowires could affect various performance properties based upon various metrics of the lengths and/or diameters. Examples of such metrics of the lengths and/or diameters can include: population densities (e.g., percentages of occurrence for ranges of lengths and/or diameters), average(s), and the like.

In view of the above, the present disclosure need not be limited to any specific performance property and/or to any specific dimensioning/metric of nanowire lengths and/or diameters.

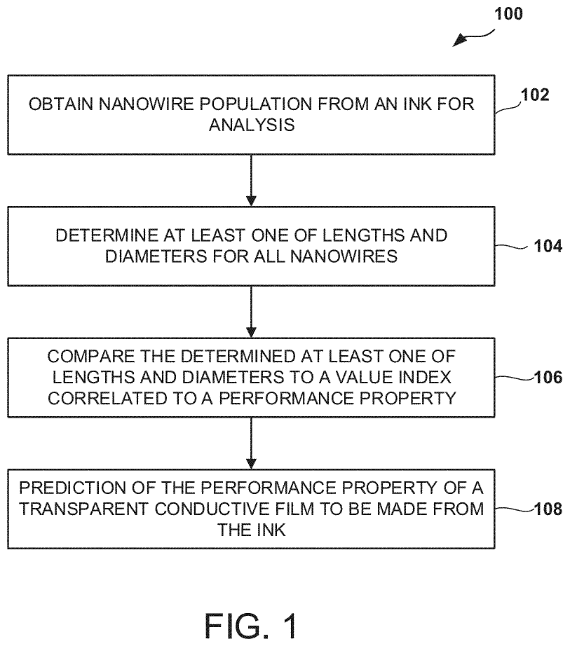

As such, the present disclosure provides the following example method 100 (FIG. 1) for predicting at least one performance property of a transparent conductive film to be made from an ink containing nanowires prior to making the transparent conductive film. The method 100 includes the step 102 of obtaining a nanowire population from the ink for analysis. The method 100 includes the step 104 of determining at least one of lengths and diameters for all the nanowires within the population from the ink. The method 100 includes the step 106 of comparing the determined at least one of lengths and diameters to a value index that is correlated to the at least one performance property of the to-be-made transparent conductive film. The result is a prediction of the at least one performance property of the transparent conductive film to be made from the ink, as is shown at 108.

Following is discussion showing application of the methodology of the present disclosure. Provided are example studies.

As an example study, correlation study is provided which compares two samples of nanowires. The samples of nanowires are identified herein as 18E0039 PR3 and 18F0041 PR3.

Within this example study, correlation analysis is performed. Within an example, both the lengths and the diameters of the nanowires are measured. Further within an example, the lengths and the diameters of the nanowires are measured simultaneously. Further within an example, such measurement is via a microscope. Still further within an example, dark field microscopy is utilized. It is to be appreciated that different measurement techniques, devices, etc. can be utilized and as such specifics need not be specific limitations upon the present disclosure and that different measurement techniques, devices, etc. are within the scope of the present disclosure.

Specifically, within the example, nanowires being considered are primarily nanowires, with the batch having undergone some purification processing in an effort to remove nanostructures that are not nanowires.

In order to quantify the number of nanowires in each batch, we have also calculated the percentage of analyzed nanowires with the following equation:

d>d_{AVE}+fσ_{d}

where f is a constant and it is to understood that this is only a rough criterion.

As an example of wire populations that could be present attention is directed to Table 1 in which segregation by both length and diameter is provided. Each column and row a certain range. For example, column 3 represents nanowires between 5 and 7.5 microns long, while row 4 represents nanowires with a diameter between 2.4 and 3.2 in arbitrary units.

TABLE 1

| 3199 | wires | 1 | 2 | 3 | 4 | 5 | 6 | 7 | 8 |
|---|---|---|---|---|---|---|---|---|---|
| 0 | 0 | 0 <= l < 2.5 | 2.5 <= l < 5 | 5 <= l < 7.5 | 7.5 <= l < 10 | 10 <= l < 12.5 | 12.5 <= l < 15 | 15 <= l < 17.5 | 17.5 <= l < 20 |
| 1 | 0 <= d < 0.8 | 0 | 0 | 0 | 0 | 0 | 0 | 0 | 0 |
| 2 | 0.8 <= d < 1.6 | 0 | 2 | 1 | 0 | 0 | 0 | 0 | 0 |
| 3 | 1.6 <= d < 2.4 | 6 | 403 | 464 | 372 | 252 | 168 | 106 | 66 |
| 4 | 2.4 <= d < 3.2 | 7 | 239 | 235 | 160 | 139 | 99 | 85 | 60 |
| 5 | 3.2 <= d < 4 | 5 | 39 | 32 | 20 | 13 | 4 | 2 | 2 |
| 6 | 4 <= d < 4.8 | 2 | 6 | 5 | 8 | 1 | 2 | 1 | 0 |
| 7 | 4.8 <= d < 5.6 | 0 | 2 | 2 | 1 | 1 | 1 | 1 | 0 |
| 8 | 5.6 <= d < 6.4 | 0 | 2 | 4 | 0 | 0 | 1 | 0 | 0 |
| 9 | 6.4 <= d < 7.2 | 0 | 1 | 1 | 1 | 0 | 0 | 0 | 0 |
| 10 | 7.2 <= d < 8 | 0 | 2 | 0 | 0 | 0 | 0 | 0 | 0 |

Table 2 shows a normalization of the populations by the maximum count in any bin.

TABLE 2

| | | 1 | 2 | 3 | 4 | 5 | 6 | 7 | 8 |
|---|---|---|---|---|---|---|---|---|---|
| 0 | 0 | 0 <= l < 2.5 | 2.5 <= l < 5 | 5 <= l < 7.5 | 7.5 <= l < 10 | 10 <= l < 12.5 | 12.5 <= l < 15 | 15 <= l < 17.5 | 17.5 <= l < 20 |
| 1 | 0 <= d < 0.8 | 0.00 | 0.00 | 0.00 | 0.00 | 0.00 | 0.00 | 0.00 | 0.00 |
| 2 | 0.8 <= d < 1.6 | 0.00 | 0.00 | 0.00 | 0.00 | 0.00 | 0.00 | 0.00 | 0.00 |
| 3 | 1.6 <= d < 2.4 | 0.01 | 0.87 | 1.00 | 0.80 | 0.54 | 0.36 | 0.23 | 0.14 |
| 4 | 2.4 <= d < 3.2 | 0.02 | 0.52 | 0.51 | 0.34 | 0.30 | 0.21 | 0.18 | 0.13 |
| 5 | 3.2 <= d < 4 | 0.01 | 0.08 | 0.07 | 0.04 | 0.03 | 0.01 | 0.00 | 0.00 |
| 6 | 4 <= d < 4.8 | 0.00 | 0.01 | 0.01 | 0.02 | 0.00 | 0.00 | 0.00 | 0.00 |
| 7 | 4.8 <= d < 5.6 | 0.00 | 0.00 | 0.00 | 0.00 | 0.00 | 0.00 | 0.00 | 0.00 |
| 8 | 5.6 <= d < 6.4 | 0.00 | 0.00 | 0.01 | 0.00 | 0.00 | 0.00 | 0.00 | 0.00 |
| 9 | 6.4 <= d < 7.2 | 0.00 | 0.00 | 0.00 | 0.00 | 0.00 | 0.00 | 0.00 | 0.00 |
| 10 | 7.2 <= d < 8 | 0.00 | 0.00 | 0.00 | 0.00 | 0.00 | 0.00 | 0.00 | 0.00 |

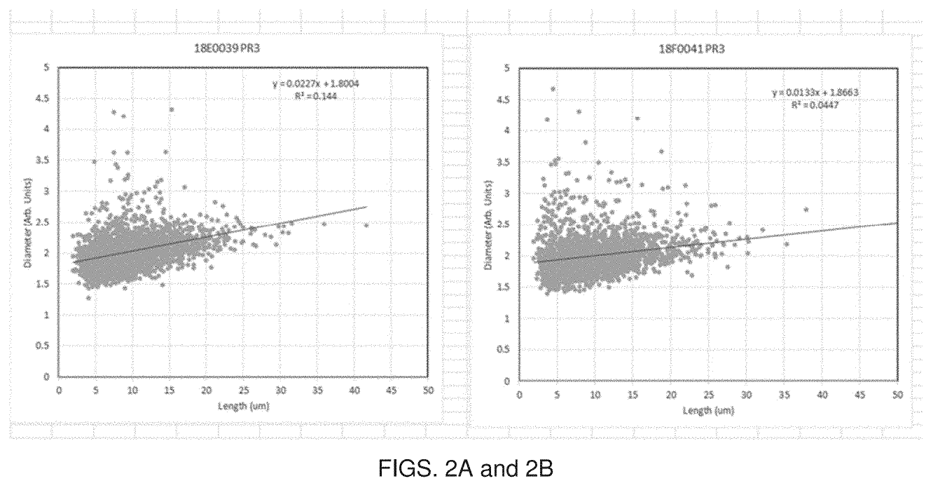

In order to visualize the number of nanowires in each batch, attention is directed to FIGS. 2A and 2B, which are scatter plots for the samples identified herein as 18E0039 PR3 and 18F0041 PR3. It is to be noted that Batch 18F0041 PR3 tends to have shorter, larger diameter nanowires. Note the greater grouping toward a shorter length range and greater grouping toward a larger diameter range. As a numerical results comparison, length (I) and diameter (d) results from the analysis, with d>d_{AVE}+fσ_{d} (f is constant) are shown in Table 3.

TABLE 3

| | | | | % of wires with d greater than | | |
|---|---|---|---|---|---|---|
| | | | | than d(Avg) + f * d(St. Dev.) | | |
| | l(Avg.) (um) | d(Avg.) | d(St. Dev.) | f = 2 | f = 3 | f = 4 |
| 18E0039 PR3 | 9.5 | 2.01 | 0.26 | 2.36 | 0.99 | 0.46 |
| 18F0041 PR3 | 10.2 | 2.00 | 0.31 | 4.04 | 1.52 | 0.64 |

With this gathered information about the two inks, films were made using each respective ink. Films made using nanowires from Batch 18F0041 PR3 performed worse than films made using Batch 18E0039 PR3. Films using ink from Batch 18F0041 PR3 had higher optical haze at the same electrical resistance. It is to be noted that Batch 18F0041 PR3 has shorter, larger diameter wires. Note that the higher optical haze at the same electrical resistance is consistent with the population of shorter, larger diameter wires seen in batch 18F0041 PR3. Thus, identification of this dimension characteristic is useable to predict at least one performance property of the to-be-made transparent conductive film. There is a correlation of presence of shorter, larger diameter nanowires to higher optical haze.

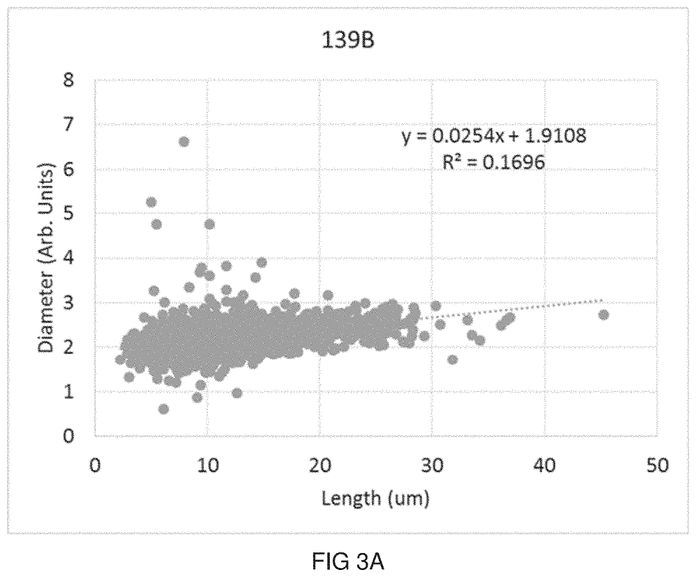

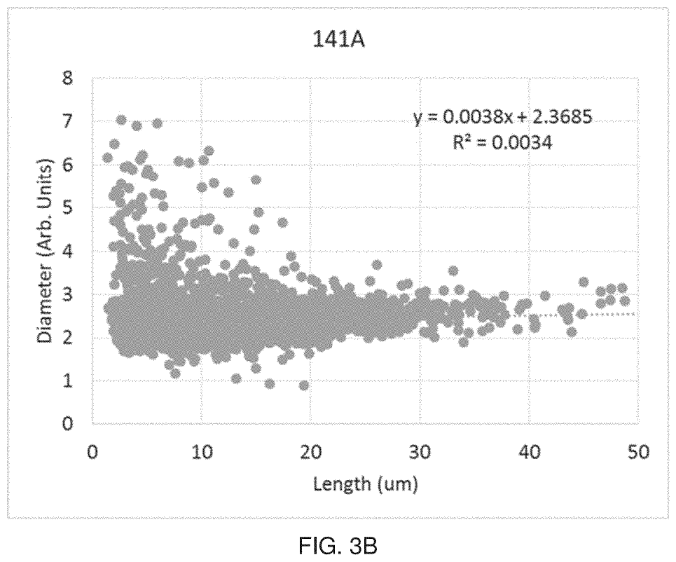

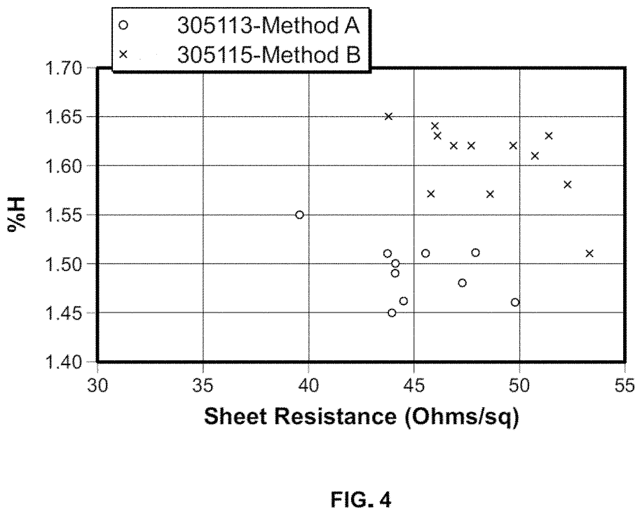

As another example, there is provided a comparison of inks which are identified as 139B and 141A. See Table 4 below. Also, see FIGS. 3A and 3B, which are scatter plots for the samples identified herein as 139B and 141A. It appears that there are many more short, fat nanowires in the ink used for batch 141A. The average diameter for the 141A batch also appears to be 10.6% larger than the 139 ink. This 10.6% refers to a difference between values 2.19 and 2.42. It is to be noted that the batch which performed poorly had both a larger diameter and more short, large diameter nanowires.

SEM results gave 141A batch 6.4% larger in diameter. Such is determined via the following equation:

(% Large d)=(# nanowires with d>d_{AVE}+4σ_{d})/(total # wires analyzed)

TABLE 4

| | Length | Diameter | St. Dev. d | % Large d | Length (Clemex) |
|---|---|---|---|---|---|
| 139B | 10.90 | 2.19 | 0.27 | 0.3% | 10.40 |
| 141A | 12.22 | 2.42 | 0.47 | 1.2% | 12.60 |

These results are consistent with worse electrical/optical performance when the ink of batch PC-141 is used to produce a film.

It is to be appreciated that no single specifics need be limitation upon this present disclosure and the method herein. The aspect of dimension(s) of the nanowires is just used to predict film performance.

As another example, Table 5 below shows the metrics for batches 306113 and 306115. In general, the batch 306115 has a population of shorter, larger diameter nanowires. Such property of shorter, larger diameter nanowires is absent from 306113. As can be appreciated upon viewing FIG. 4 and Table 6, batch 306115 yields inferior electro-optical performance.

TABLE 5

| | | | | % of wires with d greater than | | |
|---|---|---|---|---|---|---|
| | | | | than d(Avg) + f * d(St. Dev.) | | |
| | l(Avg.) (um) | d(Avg.) | d(St. Dev.) | f = 2 | f = 3 | f = 4 |
| [symbol] Method A | 9 | 2.2 | [symbol] | [symbol] | 0.6 | 0.26 |
| [symbol] Method B | 9 | 2.27 | 0.34 | [symbol] | [symbol] | [symbol] |

[symbol]

indicates data missing or illegible when filed

TABLE 6

| Sample ID | Synthesis | % T | % Haze | R |
|---|---|---|---|---|
| [symbol] | Method A | [symbol] | [symbol] | [symbol] |
| [symbol] | Method B | 91.4 | [symbol] | [symbol] |

[symbol]

indicates data missing or illegible when filed

It is worth noting that that the haze numbers within table 6 have a significant background contribution due to the substrate. Such can be about 1%. So, the difference in haze is actually substantial/noteworthy than what the the raw numbers suggest without subtracting the haze contributed by the substrate.

As mentioned, determination of at least one of lengths and diameters for all the nanowires within the population from the ink is part of the methodology of this disclosure. Also, as mentioned any process to determine at least one of lengths and diameters for all the nanowires can be utilized. As mentioned, an example includes the use of a spin coater and a microscope, with the microspore in reflected light, dark field mode, are utilized. For information regarding such an example, the following is provided.

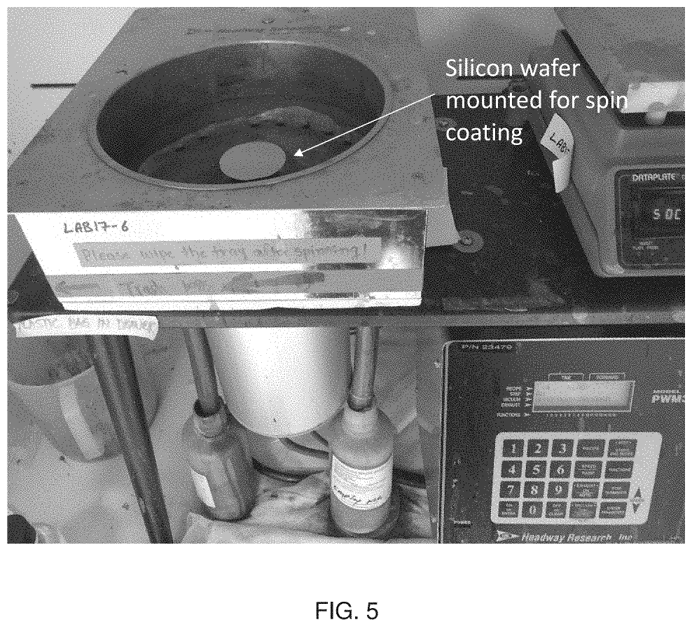

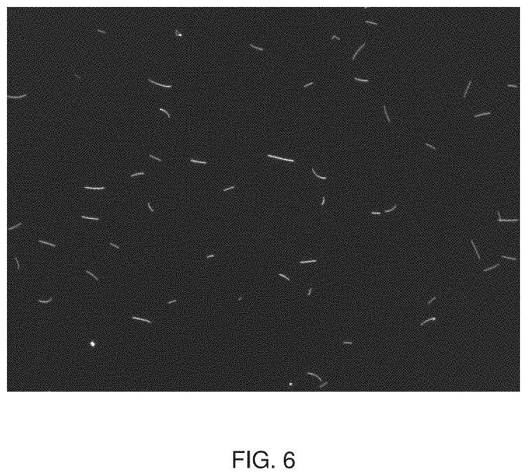

Turning back to the example that employs a spin coater and a microscope, the following is provided as further information concerning such an example. A spin coater, such as the example shown within FIG. 5, can be utilized. A dilute suspension of nanowires in the solvent IPA can be spin coated at 1000 RPM for 30 seconds on a silicon (Si) wafer. In an example, Si wafers are used because the captured images of nanowires on silicon provide better contrast than those taken for nanowires captured on other substrates such as glass. A typical image of nanowires on the surface is shown in FIG. 6.

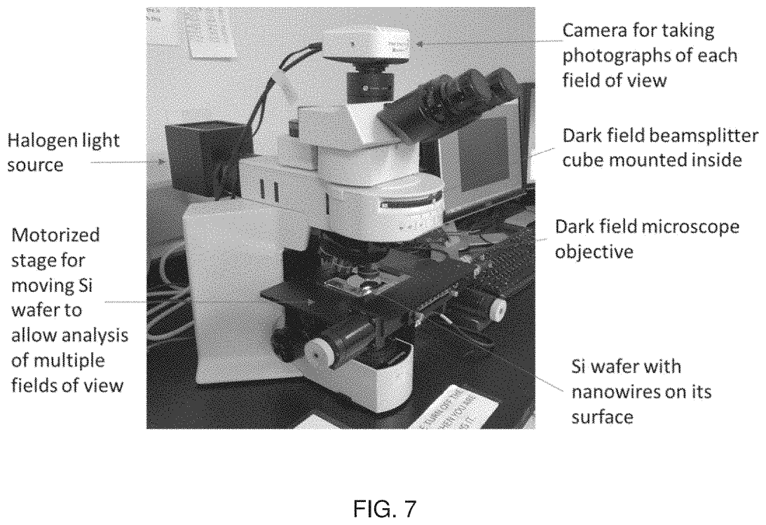

A microscope, such as the example shown within FIG. 7, can be utilized. For the shown example, the microscope is utilized in reflected light, dark field mode. The shown example is equipped with a motorized stage. Typically, images can be taken of 144 different fields of view on the Si wafer at 500× magnification. The microscope can be controlled by software which, at each field of view, takes and saves the images of the field of view, e.g., in TIF format, using a range of integration times. Depending on the type of nanowire being observed, these times may range from 10-100 ms, or 20-200 ms, or even include integration times as high as 300 or 400 ms for nanowires which have very small diameters and scatter very little light. Shorter (or longer) integration times could be used for very large (or small) diameter nanowires if desired.

With regard to the topic of possible variation of the integration time, the following is noted. Since the amount of light scattered by nanowires varies as a function of their diameter, some nanowires scatter light much more strongly than others. There must be enough light collected to be able to detect the nanowire. Dim nanowires require long integration times. Also, the intensity of any saturated pixels associated with the image of a nanowire cannot be measured. If the pixel in an image is saturated, meaning, for instance, it has the value 255 on a gray scale camera where 0 means no light and 255 is white) the true intensity of this pixel cannot be determined. The signal at this pixel might be 255 or it might be “off-scale.” Accordingly, since the true value cannot be known, that particular nanowire cannot be analyzed. It is possible to use data from an image with a shorter integration time and determine if the pixels creating the image of the nanowire are no longer saturated.

The data is then analyzed. Within an example, a software program could be used to perform such analysis. Such software calculates the length of all the nanowires using image analysis algorithms, but then additionally calculates the diameter of the nanowires according to the following protocol:

a) Determine the background intensity in the image

b) Determine the integrated intensity in a box which extends ten pixels beyond the limits for each given nanowire. Subtract out the background intensity from this total

c) Reject all nanowires which: 1) have oversaturated pixels, 2) are too close to other wires such that their integrated intensity includes contributions from other wires, 3) have an aspect ratio less than three, or 4) intersect with the edge of the image.

d) Using the background-subtracted integrated intensity and length measured for the nanowires, calculate a relative diameter using the following example relationship:

d α(Intensity/Length)^{1/3}

It is to be appreciated that the value of the exponent or power can be different from the example of ⅓. For example, the exponent could be within the range of ⅕ to ½.

Again, different methodology, structures, etc. could be used to determining at least one of lengths and diameters for all the nanowires within the population from the ink. Such different methodology, structures, etc. to determining at least one of lengths and diameters is contemplated and is to be considered within the scope of the present disclosure.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or.” In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes,” “having,” “has,” “with,” and/or variants thereof are used in either the detailed description or the claims, such terms are intended to be inclusive in a manner similar to the term “comprising.”

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method for predicting at least one performance property of a transparent conductive film to be made from an ink containing nanowires, the method comprises:
obtaining a nanowire population from the ink for analysis;
determining lengths and diameters for all the nanowires within the nanowire population from the ink; and
comparing the determined lengths and diameters to a value index that is correlated to the at least one performance property of a transparent conductive film, wherein the method further comprises:
a) calculating the lengths of the nanowires in an image;
b) determining a background intensity in the image;
c) determining an integrated intensity in a box which extends specific pixels beyond limits for each given nanowire, subtracting out the background intensity from the integrated intensity;
d) rejecting all nanowires which: 1) have oversaturated pixels, 2) are too close to other nanowires such that their integrated intensity includes contributions from other nanowires, 3) have an aspect ratio less than a specific value, or 4) intersect with an edge of the image; and
e) using the background-subtracted integrated intensity and lengths measured for the nanowires, calculate a relative diameter using the relationship:
relative diameter=d α(Intensity/Length)x, wherein x=⅕−½.

2. The method of claim 1, wherein the at least one performance property of a transparent conductive film is an optical property.

3. The method of claim 2, wherein the optical property is haze.

4. The method of claim 2, wherein the optical property is diffuse reflection.

5. The method of claim 1, wherein the method is applied as a quality control method used to avoid making a transparent conductive film using the ink when the step of comparing provides an indication that the at least one performance property of a transparent conductive film would be unsatisfactory.

6. The method of claim 1, wherein the step of comparing provides an indication that the at least one performance property of a transparent conductive film would be unsatisfactory when an amount of nanowires have diameters outside of a specified diameter criteria.

7. The method of claim 1, wherein the step of comparing provides an indication that the at least one performance property of a transparent conductive film would be unsatisfactory when an amount of nanowires have lengths outside of a specified length criteria.

8. The method of claim 1, including rejecting use of the ink based on an unacceptable number of nanowires having a length outside of a specified criterion.

9. The method of claim 1, including rejecting use of the ink based on an unacceptable number of nanowires having a length and diameter outside of a specified criterion.

10. The method of claim 1, wherein the nanowires include a conductive metal.

11. The method of claim 10, wherein the nanowires would provide an interconnected network within a transparent conductive film.

12. The method of claim 11, including analyzing a correlation based on a pre-determined criteria to predict a performance of the interconnected network within a transparent conductive film.
